(19) United States
(12) Patent Application Publication
(10) Pub. No.: US 2026/0177087 A1
(43) Pub. Date: Jun. 25, 2026

(54) THERMAL ENERGY STORAGE TANK DIFFUSER HEAD

(71) Applicant: Taco, Inc., Cranston, RI (US)

(72) Inventor: Justin Jenne, Rochester, MA (US)

(21) Appl. No.: 19/425,548

(22) Filed: Dec. 18, 2025

Related U.S. Application Data
(60) Provisional application No. 63/737,408, filed on Dec. 20, 2024.

(51) Int. Cl. F15D 1/00; F28D 21/00

(52) U.S. Cl. CPC F15D 1/0005; F28D 2021/0019

(57) ABSTRACT

A diffuser head for a thermal energy storage tank. The diffuser head includes an inlet portion having an inlet with a first cross-sectional area measured perpendicular to a vertical axis of the diffuser, and an outlet portion having an outlet with a second cross-sectional area larger than the first cross-sectional area. The diffuser head includes a diffuser portion disposed between the inlet portion and the outlet portion. The diffuser portion has a diffuser cross-section substantially perpendicular to the vertical axis and the diffuser cross-section gradually increases from the inlet portion to the outlet portion. The diffuser head includes a plurality of baffles spanning the diffuser portion between the inlet and the outlet and substantially perpendicular to the vertical axis of the diffuser head, each baffle forming one or more slots configured to allow a fluid flow through the baffles.

### CROSS-REFERENCE TO RELATED APPLICATIONS

This application claims priority to U.S. Provisional Application No. 63/737,408, filed Dec. 20, 2024, the disclosure of which is incorporated by reference herein in its entirety.

### TECHNICAL FIELD

The present disclosure relates generally to thermal energy storage (TES) systems, and more particularly to a diffuser head for TES tanks used in cooling and heating applications.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Certain facilities, such as data centers, may house critical IT equipment and/or other components that benefit from robust cooling systems to prevent overheating and potential failure of electronics. Such cooling systems typically utilize chillers to supply chilled water directly to the equipment under normal operating conditions. However, such facilities may face challenges in maintaining continuous cooling during power outages or other disturbances that may affect the operation of the primary cooling infrastructure.

To address this issue, thermal energy storage (TES) systems have been implemented to enhance the cooling resilience of data centers and other facilities. TES systems incorporate buffer tanks to store pre-chilled water that may provide uninterrupted cooling of IT equipment during power outages until power may be restored or until backup generators come online. In the event of a power failure, the TES system may circulate water into the buffer tanks (i.e., TES tanks) at a first end of the tank (i.e., a tank top), while pre-chilled water or other fluid coolant stored in the tanks may be supplied from a second end of the tank (e.g., a tank bottom) to cool the equipment until the chillers can be restarted. In some systems, such as heat pump systems, TES systems may be used to store warm water for circulation into heating systems.

Traditionally, TES buffer tanks have been designed to hold water at atmospheric pressure, which is generally less than 15 psi. However, as data center requirements evolve and cooling demands increase, there is a growing need for TES buffer tanks capable of holding water at pressures exceeding 15 psi. This shift in pressure requirements presents new challenges in the design and implementation of TES systems. For example, the use of higher pressure TES buffer tanks may necessitate compliance with industry standards, such as those set by the American Society of Mechanical Engineers (ASME) for pressure vessels.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In some embodiments, the disclosure describes a diffuser head for a thermal energy storage tank. The diffuser head may include an inlet portion having an inlet with a first cross-sectional area measured perpendicular to a vertical axis of the diffuser and an outlet portion having an outlet with a second cross-sectional area larger than the first cross-sectional area. The diffuser head may include a diffuser portion disposed between the inlet portion and the outlet portion. The diffuser portion may have a diffuser cross-section substantially perpendicular to the vertical axis, and the diffuser cross-section may gradually increase from the inlet portion to the outlet portion. The diffuser head may include a plurality of baffles spanning the diffuser portion between the inlet and the outlet and substantially perpendicular to the vertical axis of the diffuser head, each baffle forming one or more slots configured to allow a fluid flow through the baffles.

In some embodiments, the disclosure describes a thermal energy storage system. The system may include a tank having a tank vertical axis and a diffuser head disposed within the tank. The diffuser head may have a diffuser vertical axis coaxial with the tank vertical axis. The diffuser head may include an inlet portion having an inlet with a first cross-sectional area and an outlet portion having an outlet with a second cross-sectional area larger than the first cross-sectional area. The diffuser head may include a diffuser portion disposed between the inlet portion and the outlet portion. The diffuser portion may have a diffuser cross-section substantially perpendicular to the diffuser vertical axis, where the diffuser cross-section may gradually increase from the inlet portion to the outlet portion. The diffuser head may include a plurality of baffles spanning the diffuser portion in a direction substantially perpendicular to the diffuser vertical axis between the inlet and the outlet. Each baffle may form one or more slots configured to allow a fluid flow through the baffles. The inlet may be configured to receive fluid from a tank inlet of the tank and the outlet may be configured to discharge the fluid into an interior of the tank.

In some embodiments, the disclosure describes a method of diffusing a coolant fluid. The method includes providing a diffuser head disposed within a tank. The diffuser head may have a diffuser vertical axis coaxial with a tank vertical axis. The diffuser head may include an inlet with a first cross-sectional area, an outlet with a second cross-sectional area larger than the first cross-sectional area, and a diffuser portion disposed between the inlet and the outlet. The diffuser portion may have a diffuser cross-section substantially perpendicular to the diffuser vertical axis. The diffuser cross-section may gradually increase from the inlet portion to the outlet portion. The diffuser head may include a plurality of baffles spanning the diffuser portion in a direction substantially perpendicular to the diffuser vertical axis between the inlet and the outlet, where each baffle may form one or more slots configured to allow fluid flow of the coolant fluid. The method may include introducing a coolant fluid through the inlet of the diffuser head. The coolant fluid may be conveyed along the diffuser vertical axis through the one or more slots of the plurality of baffles from the inlet portion to the outlet portion, thereby expanding flow area and reducing flow momentum of the coolant fluid. The method may include collecting, in an interior of the tank, the diffused coolant fluid from the outlet of the diffuser head.

### BRIEF DESCRIPTION OF DRAWINGS

The appended claims set forth with particularity certain novel features that are considered characteristic of one or more embodiments of the present disclosure. The embodiments of the disclosure itself; however, both as to its structure and operation together with the additional objects and advantages thereof are best understood through the following description when read in conjunction with the accompanying drawings. The components in the figures are not necessarily to scale, emphasis instead being placed upon illustrating the principles of the disclosure. In the figures, like reference numerals designate corresponding parts throughout the different views, wherein:

FIG. 1 is a schematic diagram of a thermal energy storage tank with an embodiment of a diffuser head in accordance with the disclosure;

FIG. 2 is a cross-sectional perspective view of an embodiment of the diffuser head of FIG. 1;

FIG. 3 is schematic view of an embodiment of the diffuser head of FIG. 1; and

FIG. 4 is an embodiment of fluid flow through the diffuser head of FIG. 1.

Persons of ordinary skill in the art will appreciate that elements in the figures are illustrated for simplicity and clarity so not all connections and options have been shown to avoid obscuring various aspects of the disclosure. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present disclosure now will be described more fully hereinafter with reference to the accompanying drawings, which form a part hereof, and which show, by way of illustration, specific exemplary embodiments by which the disclosure may be practiced. These illustrations and exemplary embodiments are presented with the understanding that the description and figures are an exemplification of the principles of one or more embodiments of the disclosure. The disclosure may be embodied in many different forms and should not be construed as limited to the embodiments set forth herein; rather, these embodiments are provided so that this disclosure will be thorough and complete, and will fully convey the scope of the disclosure to those skilled in the art. Among other things, the present disclosure may be embodied as methods or devices. The following detailed description is, therefore, not to be taken in a limiting sense.

Throughout the disclosure and claims, the following terms take the meanings explicitly associated herein, unless the context clearly dictates otherwise. The phrase “in one embodiment” as used herein does not necessarily refer to the same embodiment, although it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The figures depict embodiments for purposes of illustration only. One skilled in the art will readily recognize from the following discussion that alternative embodiments of the structures and methods illustrated herein may be employed without departing from the principles described herein.

In general, the disclosure describes diffuser heads configured for use within thermal energy storage (TES) tanks that may be employed in cooling or heating systems across facilities such as data centers, hospitals, campuses, commercial buildings, etc. TES tanks may buffer thermal loads and support continuous operation across variable conditions, including peak demand or interruptions in primary equipment. In some embodiments, TES installations may be integrated with chilled-water plants, heat-pump loops, district energy networks, or process cooling lines, and may operate at atmospheric or elevated pressures subject to applicable vessel standards.

The disclosure describes embodiments of a diffuser head that may be suited for top-mounted configurations in TES tanks, which may leverage gravity to guide flow through successive baffles. In some embodiments, the diffuser head may be adapted to varied tank geometries, diameters, and head contours encountered across facility types. Within such tanks, layers of fluid may form based on temperature differences, which may include a surface layer, a colder (or warmer) bulk layer, and an intermediate transition region that may be referred to as a thermocline. In some embodiments, the diffuser head may be disposed near a dished head portion of a TES tank and may be configured to gradually expand a flow cross-section and redistribute momentum using horizontal baffles with slots. A geometric expansion of cross-section from an inlet toward an outlet may reduce local fluid velocity for a given volumetric flow rate, and staged slotting through multiple baffles may promote uniform discharge across a fluid surface while aligning flow generally parallel to a tank's vertical axis.

In some embodiments, the diffuser head may include an inlet portion, an outlet portion, and a diffuser portion. The inlet portion may include an inlet with a first cross-sectional area, while the outlet portion may have an outlet with a second cross-sectional area that may be larger than the first cross-sectional area. The diffuser portion may be disposed between the inlet portion and the outlet portion and may include a plurality of horizontal baffles substantially perpendicular to fluid flow between the inlet and the outlet. In some embodiments, the fluid entering the inlet portion may flow through one or more slots in each of the one or more baffles, thereby slowing down on its way to the outlet portion. In some embodiments, the outlet portion may distribute the fluid into the cooled fluid in the TES tank for gradual mixing.

Example configurations may be implemented with various expansion profiles (e.g., conical, dished, compound curves, ogive or spline-defined contours), slot patterns (e.g., concentric, radial, spiral, non-uniform arrays), spacing schemes (uniform or graded), materials (e.g., stainless steels, coated carbon steels, polymers, composites), and mounting approaches (e.g., welding, brackets, bolted flanges, clamps). In some embodiments, sensors, access ports, and removable sub-assemblies may be incorporated to facilitate inspection, cleaning, or maintenance without constraining the disclosed features.

Accordingly, in some embodiments, the diffuser head may efficiently distribute fluid into a TES tank by receiving coolant fluid at the inlet with an inlet velocity and discharging the coolant fluid through the outlet at an outlet velocity. The gradually increasing cross-section of the diffuser portion may allow for a controlled expansion of the fluid flow, which may reduce turbulence and promote uniform distribution. The horizontal baffles may further regulate the flow, creating a more even distribution of coolant across the surface area of the fluid in the TES tank.

The disclosed diffuser head may provide several advantages in TES systems. For example, the diffuser head may promote more efficient use of tank volume by helping ensure uniform coolant distribution, potentially reducing the required tank size for a given application, and/or reducing the number of tanks needed to cool a particular facility. The diffuser head may minimize mixing between different temperature layers within the tank, improving thermal stratification and overall system efficiency. Additionally, the horizontal baffles may help in reducing turbulence and promoting parallel flow at the outlet, which aligns with the vertical axis of the tank and minimizes unwanted mixing.

Another advantage of some embodiments of the disclosed head diffuser may be that the horizontal baffles may be produced separately and subsequently assembled within the TES tanks. Such modular construction may allow for more efficient construction processes, such as by reducing or eliminating the need to manually install baffles within the TES tank directly. Additionally, the modular diffuser heads or portions of the diffuser heads may provide for upgrades to existing TES tanks, as well as providing relatively easy replacement at end-of-life or for maintenance purposes.

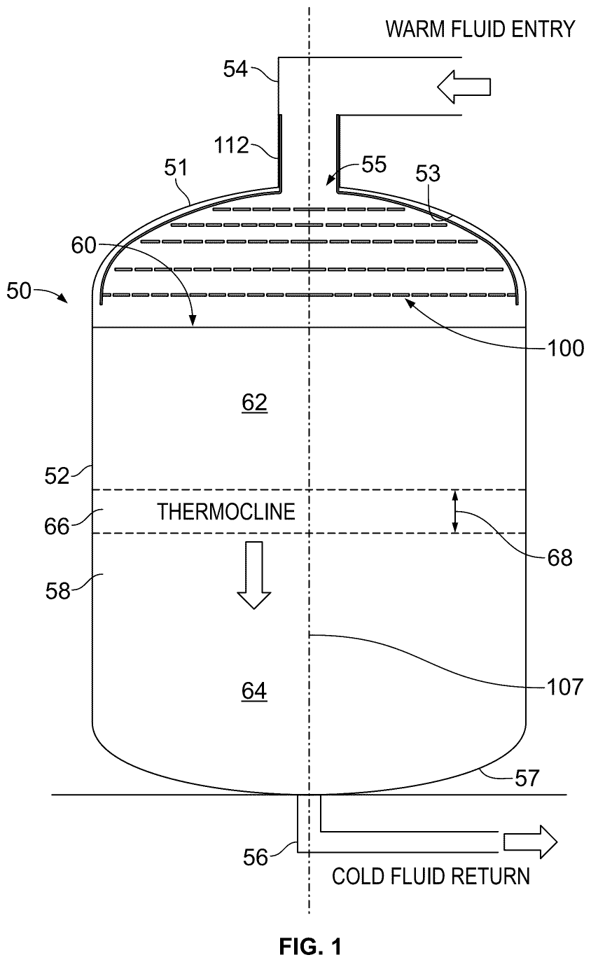

FIG. 1 shows a schematic diagram of a TES tank 50 including an embodiment of a diffuser head 100. The TES tank 50 may have a vertical axis 107 and may include an outer tank shell 52 that may hold cooling (or heating) fluid 58 until needed. Throughout, while embodiments for cooling will primarily be described, those skilled in the art will understand that the same or substantially similar systems may be used for heating and/or warming applications. In some embodiments, the diffuser head 100 may be disposed within a head portion 51 of the TES tank 50, which may have curved or dished shape such that the head portion may form a concave surface with respect to an interior of the tank. In some embodiments, the diffuser head 100 may have a similarly shaped contour such that the diffuser head may be substantially flush against an interior surface 53 of the head portion 51. In some embodiments, it is also contemplated that there may be gaps between the diffuser head 100 and the outer tank shell 52. In some embodiments, the diffuser head 100 may be secured in place within the TES tank 50 by any suitable means, such as welding, adhesives, fasteners, etc. In some embodiments, the diffuser head 100 may include an inlet 112 that may extend through an opening 55 in the head portion 51 of the outer tank shell 52 so as to fluidly connect to a fluid entry conduit 54. In some embodiments, it is contemplated that the outer tank shell 52 may itself connect to the fluid entry conduit 54, and the inlet 112 may be disposed within the tank shell 52.

When in operation, the TES tank 50 may receive cooling fluid or heating fluid (e.g., from a cooling or heating system) through a warm (or cold) fluid entry conduit 54, and may circulate fluid back into the cooling system via a cold (or warm) fluid return conduit 56. In some embodiments, upon entry through the entry conduit 54, the warm fluid may pass through the diffuser head 100 before being deposited onto a fluid surface 60 of the cooling fluid 58. As warm fluid is introduced into the cooling fluid 58, the fluid near the fluid surface 60 may begin to warm up due to the gradual mixing of the incoming warm fluid with the cooling fluid in the TES tank 50. Accordingly, a transition layer, called a thermocline 64, may form between the warm fluid 62 at or near the fluid surface 60 and the cold fluid 64 at or near a bottom portion 57 of the tank. In some embodiments, the warm fluid 62 may be substantially uniform in temperature and the cold fluid 64 may be substantially uniform in temperature, while the fluid in the thermocline 66 may exist at a temperature gradient between the warm fluid and the cold fluid. As more used coolant fluid continues to be introduced into the tank via the diffuser head 100 and cold fluid moves out of the tank via the cold fluid return 56, the thermocline 66 may move from near the surface 60 down toward the bottom portion 57 of the tank 50. Eventually, if the thermocline 66 reaches the bottom 57 of the tank 50, the fluid flowing out of the cold fluid return 56 and back into the cooling system will become warmer and become less effective as a coolant.

Accordingly, the longer it takes for the thermocline 66 to transition to the bottom 57 of the tank 50, the longer the TES tank 50 may be effective as or part of a cooling back-up system. In some embodiments, it may therefore be advantageous to minimize the thermocline height 68 and/or slow its growth in order to maximize the time in which the cold fluid 64 remains at a functionally cooling temperature. In some embodiments, by expanding the surface area and reducing the turbulence of the warm fluid joining the cooling fluid 58 through the inlet 112, the disclosed diffuser head 100 may help maximize a TES tank's 50 ability to provide cooling fluid to the cooling system at an effective cooling temperature.

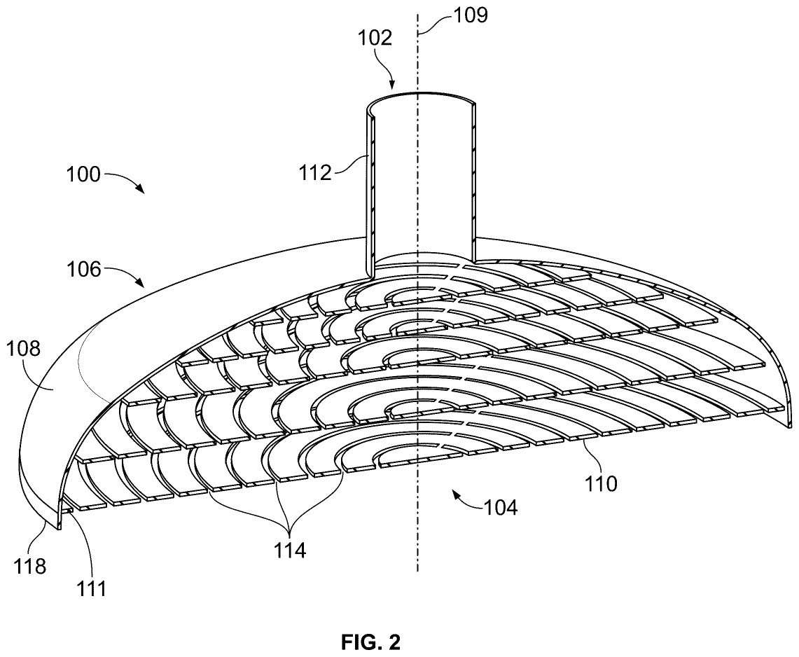

FIG. 2 is cross-sectional view of an embodiment of the diffuser head 100. In some embodiments, the diffuser head 100 may include an inlet portion 102, an outlet portion 104, and a diffuser portion 106 disposed between the inlet portion and the outlet portion. In some embodiments, the diffuser portion 106 may include an outer diffuser wall 108 and one or more horizontal baffles 110 disposed between the inlet portion 102 and the outlet portion 104.

In some embodiments, the inlet portion 102 may be configured with an inlet 112 that may be substantially circular in cross section, though other cross-sectional shapes are contemplated in other embodiments. In some embodiments, the cross-sectional area of the inlet 112 may be smaller than a cross-sectional area of an outlet 118 included in the outlet portion 104. With such a diffuser head 100, a coolant, such as water, may enter the diffuser head 100 at the inlet 112 with an inlet velocity and exit the diffuser head 100 through the outlet 118 with an outlet velocity that may be lower than the inlet velocity. In some embodiments, the fluid exiting the diffuser head 100 through the outlet 118 may also be less turbulent than the fluid entering the diffuser head through the inlet 112.

In some embodiments, the diffuser portion 106 may have a generally circular cross-section. This cross-section may gradually increase from the inlet portion 102 to the outlet portion 104. The outer diffuser wall 108 may define a cross-sectional area of the diffuser head 100 at a given vertical position along a vertical axis 109 of the diffuser head 100. The diffuser portion 106 may include one or more horizontal baffles 110 that may be arranged to span the diffuser portion in a horizontal direction substantially perpendicular to vertical axis 109 and the general direction of fluid flow between the inlet 112 and the outlet 118. In some embodiments, the vertical axis 109 of the diffuser head 100 may be coaxial with the vertical axis 107 of the TES tank 50 shown in FIG. 1. In some embodiments, the baffles 110 may be substantially circular or round and may span substantially the entire cross-section of the diffuser portion 106. In some embodiments, because the cross-section of the diffuser head 100 may gradually increase moving from the inlet 112 toward the outlet 118 along the vertical axis 109, the baffles 110 may similarly correspondingly increase in surface area and moving from the inlet toward the outlet. In other words, in some embodiments, each successive baffle 110 moving between the inlet 112 and the outlet 118 may have a larger surface area than the last. In some embodiments, the one or more baffles 110 may be connected to an inner portion of the outer diffuser wall 108 at an outer edge 111 of each baffle 110.

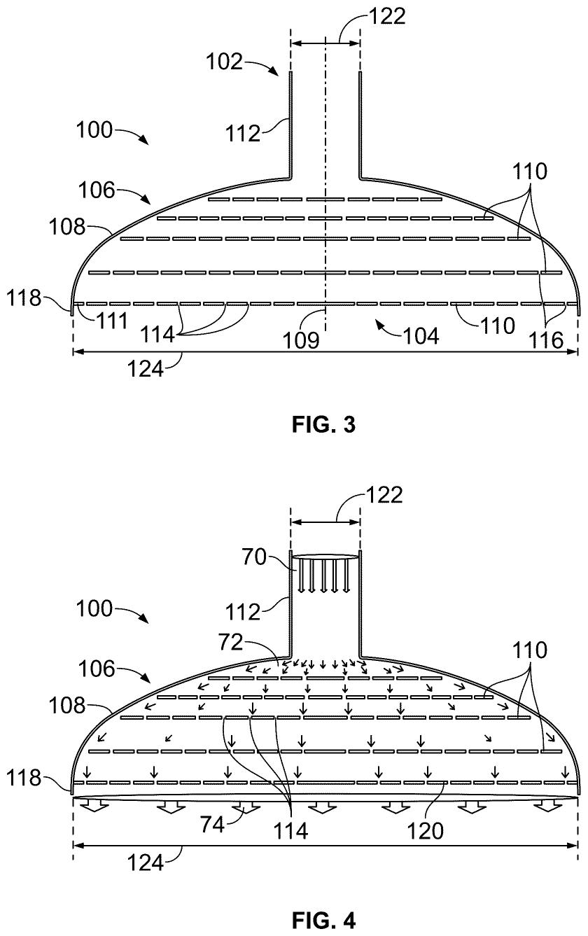

Referring to FIG. 3, an inlet cross section 122 of the inlet 112 may be smaller than an outlet cross section 124 at the outlet 118. Each baffle 106 between the inlet 112 and the outlet 118 may include one or more slots 114. In some embodiments, the slots 114 may allow for the warm fluid entering the diffuser head 100 to flow through the baffles 110 as the fluid travels between the inlet 112 and the outlet 118. In some embodiments, the slots 114 may be substantially circular and may be arranged in a concentric pattern between the vertical axis 109 of the diffuser head 100 and the outer diffuser wall 108. In some embodiments, an outermost slot 116 in each of the baffles 110 may be spaced away from the outer diffuser wall 108. In such embodiments, the baffles 110 may prevent fluid from flowing between the baffle 110 and the outer diffuser wall 108. In some embodiments, such a configuration may promote full use of the cross-sectional area in the transition between the inlet 112 and the outlet 118 and may aid in aligning fluid flow velocities parallel to a vertical axis of the TES tank 50. In some embodiments, the slots 114 in the baffles 110 may have a width of about ⅜″ or about ½″ each. In some embodiments, the width may be related to the cross-sectional area of the inlet 112. Specifically, a diffuser head that may have a relatively large inlet 112 may have larger slot widths as compared to a diffuser head having a relatively smaller inlet.

In some embodiments, the slots 114 may be substantially circular in shape. The circular shape may promote smooth flow as the coolant fluid passes through the baffles 110. In some embodiments, the circular slots 114 may be arranged in a concentric pattern between the vertical axis 109 of the diffuser head and the outer diffuser wall 108. This concentric arrangement may help achieve a symmetrical flow distribution, helping the fluid spread evenly across the cross-section of the diffuser head as it progresses towards the outlet 118. In some embodiments, as the fluid passes through each successive baffle 110, it may undergo further redistribution. Each stage may contribute to the overall goal of achieving a uniform flow profile at the outlet 118. The cumulative effect of passing through multiple baffled stages may help provide a well-distributed flow pattern.

In some embodiments, different embodiments of diffuser heads may be designed based on specific application requirements. These may include variations in the number of horizontal baffles 110, the shape and arrangement of slots 114 in the baffles, or the overall geometry of the diffuser portion 106. By way of example only, some embodiments of diffuser heads may include three, five, or seven horizontal baffles. In some embodiments, the slots 114 may be circular, rectangular, or elliptical slots, and some embodiments of the diffuser head 100 may have linear or non-linear expansion profiles in the diffuser portion 106. In some embodiments, the number, size, and arrangement of the slots 114 may be optimized based on the specific flow requirements and desired performance characteristics of the diffuser head 100, the TES tank 50, and/or the cooling system overall. The slots 114 allow for a controlled passage of coolant through each baffle 110, contributing to the overall flow distribution strategy and minimizing the width of the thermocline 68.

In some embodiments, the baffles 110 may be vertically spaced in uniform manner, or may be have variable spacing. For example, in some embodiments, the baffles 110 may be spaced closer to one another near the inlet 112 and gradually spaced further from one another as the baffles near the outlet 118. In some embodiments, a portion of the diffuser head 100 adjacent or near the inlet 112 may have two, three, or more closely spaced baffles to provide initial flow control, followed by two or three more widely spaced baffles in the expanding diffuser portion. Such embodiments may offer enhanced flow control near the inlet while reducing overall pressure drop through the diffuser head.

In some embodiments, the selection of slot width may be related to the cross-sectional area of the inlet 112 and the desired flow characteristics, and may be chosen to balance factors such as flow rate, pressure drop, and distribution uniformity. In some embodiments, the specific slot width may be selected based on the overall size of the diffuser head 100 and the expected coolant flow rates. In some embodiments, the baffles 110 may include variable slot patterns. For example, the baffles 110 may have slots arranged in a spiral pattern or with varying widths from the center to the outer edge of each baffle. In some embodiments, each subsequent baffle 110 moving from the inlet 112 toward the outlet 118 may have the slots 114 evenly spaced from one another in a radial direction, such that the baffles nearest the outlet 118 have more slots than those nearest the inlet 112. In some embodiments, each subsequent baffle 110 moving from the inlet 112 toward the outlet 118 may have the same or similar numbers of slots, but the spacing between each concentric circular slot may be larger for baffles near the outlet 118 than baffles near the inlet 112.

FIG. 4 shows an embodiment of a diffuser head 100 with example fluid flow through the diffuser head 100 between the inlet 112 and the outlet 118. An inlet flow 70 may enter the diffuser head 100 at the inlet 112, which may be delivered as warmed fluid used in a cooling system and arriving such as via warm fluid entry 54 in FIG. 1. Upon exiting the inlet 112, the inlet flow 70 may encounter the first of the one or more baffles 110 disposed within the diffuser portion 106 of the diffuser head 100 and positioned generally horizontal to the direction of fluid flow between the inlet 112 and the outlet 118. The inlet flow 70 may become diffuse flow 72 as gravity pulls the fluid through the one or more slots 114 formed in each of the baffles 110. As shown, the diffuse flow 72 may gradually spread into wider and wider surface area as the fluid progresses through each subsequent baffle 110 with an increasing circumference and surface area between the inlet 112 and the outlet 118. When the diffuse flow 72 discharges from a final baffle 120 adjacent the outlet 118, the fluid may become outlet flow 74 that may discharge from the diffuser head 100 and be introduced to the cooling fluid 58 within the TES tank 50. As shown in FIG. 4, the outlet flow 74 may have a substantially larger cross section (corresponding to the outlet cross section 124) upon discharging from the diffuser head 100 as compared to the inlet flow 70 (corresponding to the inlet cross section 122), and may have a substantially lower velocity. In some embodiments, the lower velocity and larger cross section of the outlet flow 74 may provide for less disturbance of the fluid surface 60, which may result in more gradual mixing, a tighter thermocline, and increased cooling efficiency.

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A diffuser head for a thermal energy storage tank, the diffuser head comprising:
an inlet portion having an inlet with a first cross-sectional area measured perpendicular to a vertical axis of the diffuser head;
an outlet portion having an outlet with a second cross-sectional area measured perpendicular to the vertical axis of the diffuser head, the second cross-sectional area larger than the first cross-sectional area;
a diffuser portion disposed between the inlet portion and the outlet portion, the diffuser portion having a diffuser cross-section substantially perpendicular to the vertical axis, the diffuser cross-section gradually increasing from the inlet portion to the outlet portion; and
a plurality of baffles spanning the diffuser portion between the inlet and the outlet and substantially perpendicular to the vertical axis of the diffuser head, each baffle of the plurality of baffles forming one or more slots configured to allow a fluid flow through each baffle.

2. The diffuser head of claim 1, wherein the diffuser portion comprises an outer diffuser wall defining the diffuser cross-section at each vertical position along the vertical axis of the diffuser head.

3. The diffuser head of claim 2, wherein each baffle of the plurality of baffles is substantially circular and spans substantially the entire cross-section of the diffuser portion at a respective vertical position along the vertical axis.

4. The diffuser head of claim 3, wherein each of the plurality of baffles is connected to the outer diffuser wall at an outer edge of the respective baffle.

5. The diffuser head of claim 1, wherein a first baffle of the plurality of baffles has a first circumference that is less than a second circumference of a second baffle of the plurality of baffles, the second baffle being disposed between the first baffle and the outlet portion.

6. The diffuser head of claim 1, wherein the one or more slots are substantially circular.

7. The diffuser head of claim 6, wherein the one or more slots are arrayed in a concentric pattern between the vertical axis of the diffuser head and the outer diffuser wall.

8. The diffuser head of claim 7, wherein an outermost slot in each baffle of the plurality of baffles is spaced away from the outer diffuser wall such that fluid flow is prevented between the respective baffle and the outer diffuser wall.

9. A thermal energy storage system comprising:
a tank having a tank vertical axis; and
a diffuser head disposed within the tank, the diffuser head having a diffuser vertical axis coaxial with the tank vertical axis, the diffuser head comprising:
an inlet portion having an inlet with a first cross-sectional area;
an outlet portion having an outlet with a second cross-sectional area larger than the first cross-sectional area;
a diffuser portion disposed between the inlet portion and the outlet portion, the diffuser portion having a diffuser cross-section substantially perpendicular to the diffuser vertical axis, the diffuser cross-section gradually increasing from the inlet portion to the outlet portion; and
a plurality of baffles spanning the diffuser portion in a direction substantially perpendicular to the diffuser vertical axis between the inlet and the outlet, each baffle forming one or more slots configured to allow a fluid flow through the baffles,
wherein the inlet is configured to receive fluid from a tank inlet of the tank and the outlet is configured to discharge the fluid into an interior of the tank.

10. The thermal energy storage system of claim 9, wherein the diffuser portion comprises an outer diffuser wall defining the diffuser cross-section at each vertical position along the vertical axis of the diffuser head.

11. The thermal energy storage system of claim 10, wherein each of the plurality of horizontal baffles is substantially circular and spans substantially the entire cross-section of the diffuser portion.

12. The thermal energy storage system of claim 11, wherein each of the plurality of baffles is connected to the outer diffuser wall at an outer edge of the respective baffle.

13. The thermal energy storage system of claim 9, wherein a first baffle of the plurality of baffles has a first circumference that is less than a second circumference of a second baffle of the plurality of baffles, the second baffle being disposed between the first baffle and the outlet portion.

14. The thermal energy storage system of claim 9, wherein the one or more slots are substantially circular.

15. The diffuser head of claim 14, wherein the one or more slots are arrayed in a concentric pattern between the vertical axis of the diffuser head and the outer diffuser wall.

16. A method of diffusing a coolant fluid, the method comprising:
providing a diffuser head disposed within a tank, the diffuser head having a diffuser vertical axis coaxial with a tank vertical axis, wherein the diffuser head includes:
an inlet with a first cross-sectional area,
an outlet with a second cross-sectional area larger than the first cross-sectional area,
a diffuser portion disposed between the inlet and the outlet, the diffuser portion having a diffuser cross-section substantially perpendicular to the diffuser vertical axis, the diffuser cross-section gradually increasing from the inlet portion to the outlet portion, and
a plurality of baffles spanning the diffuser portion in a direction substantially perpendicular to the diffuser vertical axis between the inlet and the outlet, each baffle forming one or more slots configured to allow fluid flow of the coolant fluid;
introducing a coolant fluid through the inlet of the diffuser head, the coolant fluid being conveyed along the diffuser vertical axis through the one or more slots of the plurality of baffles from the inlet portion to the outlet portion, thereby expanding flow area and reducing flow momentum of the coolant fluid; and
collecting, in an interior of the tank, the diffused coolant fluid from the outlet of the diffuser head.

17. The method of claim 16, wherein:
each of the plurality of baffles is substantially circular and spans substantially the entire cross-section of the diffuser portion at a respective vertical position along the diffuser vertical axis; and
wherein the one or more slots are arrayed in a concentric pattern between the diffuser vertical axis and an outer diffuser wall.

18. The method of claim 18, wherein a first baffle of the plurality of baffles has a first circumference that is less than a second circumference of a second baffle of the plurality of baffles, the second baffle being disposed between the first baffle and the outlet.

19. The method of claim 16, wherein the one or more slots are substantially circular.

20. The diffuser head of claim 19, wherein the one or more slots are arrayed in a concentric pattern between the vertical axis of the diffuser head and the outer diffuser wall.
